(19) United States
(12) Patent Application Publication
(10) Pub. No.: US 2014/0215924 A1
(43) Pub. Date: Aug. 7, 2014

(54) GATE LATCH

(71) Applicant: Edward Evans, Inverell (AU)

(72) Inventor: Edward Evans, Inverell (AU)

(73) Assignee: SAFERGATE GROUP PTY LTD, Brisbane, Queensland (AU)

(21) Appl. No.: 14/239,022

(22) PCT Filed: Aug. 14, 2012
(86) PCT No.: PCT/AU2012/000950

§ 371 Date: Feb. 14, 2014

(30) Foreign Application Priority Data
Aug. 17, 2011 (AU) 2011903273

(51) Int. Cl. E05C 1/10; E06B 11/02; E05B 15/02

(52) U.S. Cl. CPC E05C 1/10; E05B 15/0205; E06B 11/02
USPC 49/394; 292/42

(57) ABSTRACT

The present invention provides a gate latch, comprising: a drop bolt mounted to a first gate member, the drop bolt mounted to a first gate member, the drop bolt moveable along a locking axis; a striker block mounted to a second gate member, the striker block comprising: a first striker surface extending away from the locking axis at a first angle; and a second striker surface extending away from the locking axis at a second angle; and a third striker surface having a tangent line substantially parallel to the locking axis; and a housing for receiving the striker block; wherein the gate latch is locked when the striker bolt is received in the housing and the drop bolt is positioned adjacent to the third striker surface of the striker block. The gate latch has use with swing gates, of the type commonly used in cattle pens.

### FIELD OF THE INVENTION

The invention relates to latches for gates. In particular, but not exclusively, the invention relates to a gate latch for use with safety gates for cattle pens to prevent injury to an operator if a beast attacks or hits a gate.

### BACKGROUND TO THE INVENTION

Swing gates are used in cattle pens, yards and races as a barrier to direct cattle and to open and close the pens, yards and races. Swing gates are generally opened or closed by an operator standing on a side of the gate that is opposite the cattle. It often happens that while opening or closing a gate, a beast becomes agitated and may attack or hit the gate. If the gate is not locked and the operator is unable to get out of the way in time, the force of the beast hitting the gate can be transferred to the operator by the gate. As cattle can be very heavy and powerful, being struck by a gate in such a manner may result in severe injury to the operator. Further, having to concentrate on a locking mechanism of the gate while staying aware of what a nearby beast is doing makes the operator's job even more difficult and hazardous. Thus the task of locking and unlocking gates is generally left to experienced operators due to the high risk of injury.

International patent application no. PCT/AU2010/001332, titled Swing Gate, and published as WIPO publication no. WO2011/047411, discloses an improved gate that is safer for an operator to open, close, lock and unlock in the presence of cattle on the other side of the gate.

However, prior art latches used to lock gates such as the swing gate described in the above international patent application can have significant disadvantages. For example, prior art latches sometimes can be difficult to close if a gate is even slightly out of alignment, and misalignment of gate hardware can be common in the rough working environment of cattle pens. Also, prior art gate latches sometimes include protruding hardware that can bruise cattle. Further, gate latches according to the prior art sometimes can require multiple movements of latch mechanisms in order to close a gate. That can cause delays in gate closings and increase risks and stress levels for both operators and cattle.

Therefore, a need exists for an improved latch for locking gates.

### OBJECT OF THE INVENTION

It is an object of the invention to overcome or at least alleviate one or more of the above problems and/or provide the consumer with a useful or commercial choice.

### SUMMARY OF THE INVENTION

In one form, although it need not be the only or indeed the broadest form, the invention resides in a gate latch, comprising:

a drop bolt mounted to a first gate member, the drop bolt moveable along a locking axis;

a striker block mounted to a second gate member, the striker block comprising:
a first striker surface extending away from the locking axis at a first angle;
a second striker surface extending away from the locking axis at a second angle; and
a third striker surface having a tangent line substantially parallel to the locking axis; and

a housing for receiving the striker block;

wherein the gate latch is locked when the striker block is received in the housing and the drop bolt is positioned adjacent to the third striker surface of the striker block.

Preferably, the first gate member is a swing gate and the second gate member is a member against which the swing gate closes.

Alternatively, the second gate member is a swing gate and the first gate member is a member against which the swing gate closes.

Preferably, the first and second surfaces are approximately orthogonal.

Preferably, the drop bolt comprises an L-shaped bar.

Preferably, the drop bolt is received in a sleeve mounted on the first gate member.

Preferably, the housing comprises a first housing surface substantially parallel to the first striker surface.

Preferably, the housing comprises a second housing surface substantially parallel to the second striker surface.

Preferably, the first striker surface, the second striker surface, and the third striker surface define a triangle.

Preferably, the striker block is positioned between two parallel bars substantially parallel to the locking axis.

Preferably, the striker block is recessed between the two parallel bars.

### BRIEF DESCRIPTION OF THE DRAWINGS

To assist in understanding the invention and to enable a person skilled in the art to put the invention into practical effect, preferred embodiments of the invention will be described by way of example only with reference to the accompanying drawings, wherein:

FIG. 1 shows a diagrammatic perspective view of a swing gate in accordance with one embodiment of the invention;

FIG. 2 shows a diagrammatic front view of the swing gate of FIG. 1;

FIG. 3 shows a diagrammatic top view of the swing gate of FIG. 1 and an operator busy locking the gate in a closed position of the gate;

FIG. 4 shows a diagrammatic top view of the swing gate of FIG. 1, showing a beast hitting the gate before the operator managed to lock the gate and how a safety section of the gate folds away as the gate hits the operator;

FIG. 5 shows a perspective view illustrating an alternative embodiment of a swing gate in a closed position, including an improved gate latch, according to an embodiment of the present invention;

FIG. 6 shows a perspective view illustrating features of the gate latch of FIG. 5 in an open position;

FIG. 7 shows a front view further illustrating the gate latch of FIG. 5 in an open position; and

FIG. 8 shows a front view further illustrating the gate latch of FIG. 5 in a closed position.

### DETAILED DESCRIPTION OF THE INVENTION

Embodiments of the present invention comprise a gate latch. Elements of the invention are illustrated in concise outline form in the drawings, showing only those specific details that are necessary to understanding the embodiments of the present invention, but so as not to clutter the disclosure with excessive detail that will be obvious to those of ordinary skill in the art in light of the present description.

In this patent specification, adjectives such as front and rear, vertical and horizontal, upper and lower, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

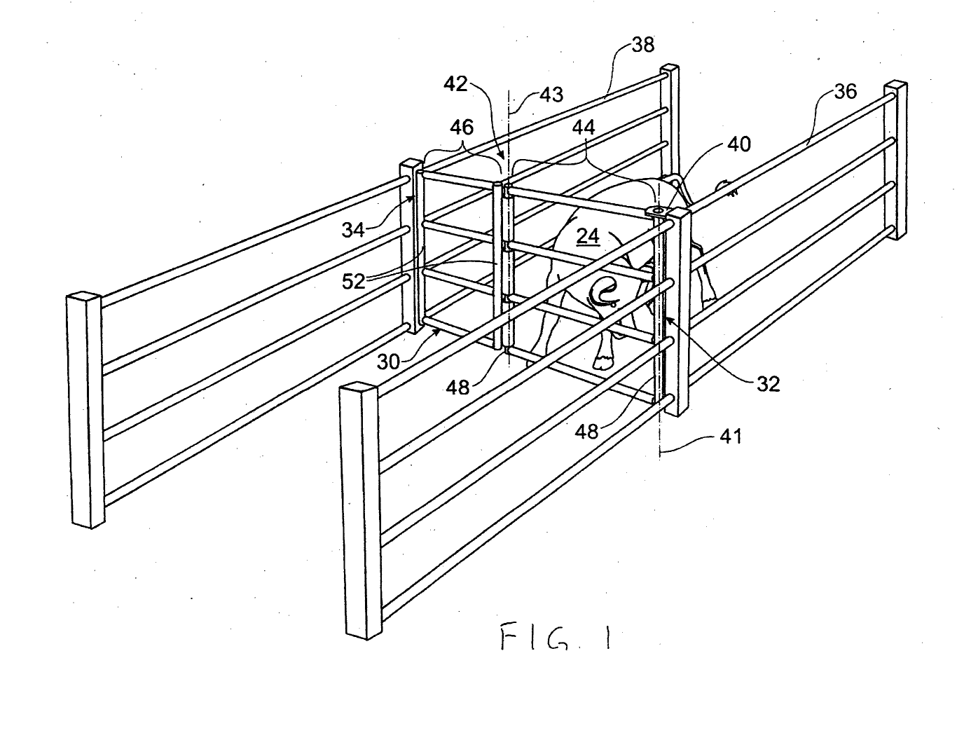

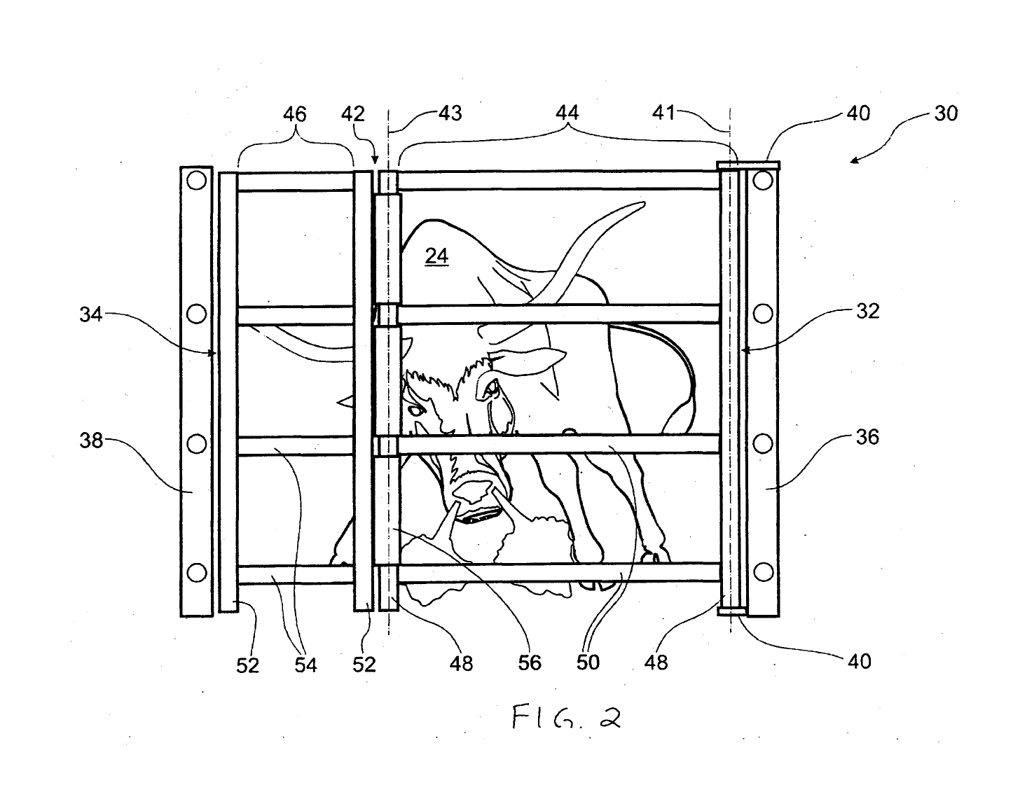

FIGS. 1 and 2 show one embodiment of a swing gate 30 in accordance with the present invention. The gate 30 can make it safer for an operator to open and close the gate 30 when a beast 24 is located nearby on an opposite side of the gate 30. The gate 30 has a pivot end 32 about which the gate 30 is pivotable and a distal end 34 remote from the pivot end 32. The gate 30 extends between two fixed rails 36, 38. The pivot end 32 is pivotally connected to the rail 36 by hinges 40 at the top and bottom of the rail 36. The gate 30 includes a centre hinge 42 between the pivot end 32 and the distal end 34. The centre hinge 42 effectively divides the gate into two sections, namely, a primary section 44 between the pivot end 32 and the centre hinge 42, and a safety section 46 between the centre hinge 42 and the distal end 34.

The primary section 44 comprises a frame of two spaced end posts 48 and cross bars 50 extending between the end posts 48. One of the end posts 48 at the pivot end 32 of the gate 10 is held between the hinges 40. The hinges 40 define a swing axis 41 between them about which the primary section 44 is pivotable between open positions and a closed position. FIGS. 1, 2 and 3 show the primary section 44 in the closed position.

The safety section 46 comprises two spaced end posts 52 and cross bars 54 extending between the end posts 52. The safety section 46 is hingedly connected to the primary section 44 by the centre hinge 42.

The centre hinge 42 comprises sleeves 56 which capture parts of the end post 48 of the primary section 44 and is welded to one of the end post 52 of the safety section 46 that is adjacent the centre hinge 42. The sleeves 56 define a vertical flap axis 43 between them about which the safety section 46 is pivotable.

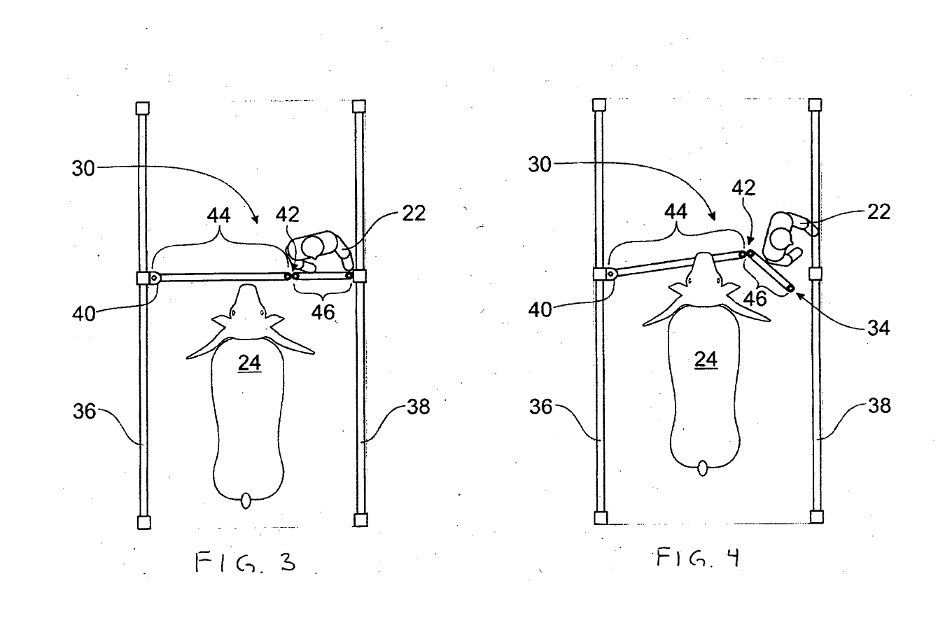

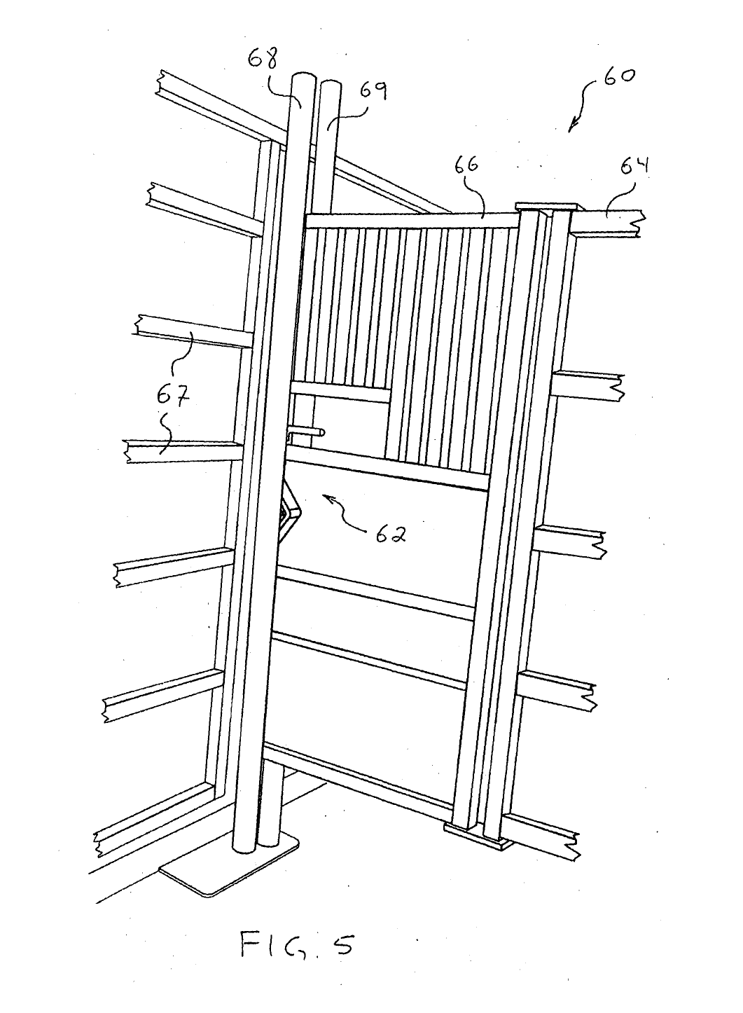

The primary section 44 can thus swing between open and closed positions about the swing axis 41 and the safety section 46 can swing into and out of parallel alignment with the primary section 44 as is described in more detail with reference to FIGS. 3 and 4. As illustrated, the primary section 44 can be significantly wider than the safety section 46.

FIG. 3 shows a top view of the swing gate 30 being closed and locked by an operator 22 in front of a beast 24. The operator 22 can lock the gate 30 in a closed position by looping a chain between the post 52 at the distal end 34 of the gate 30 and the rail 38. In doing so he locates himself on an opposite side of the gate 30 away from the beast 24. In the closed position of the gate 30, the primary section 44 of the gate 30 is perpendicular to the rails 36, 38 and the safety section 46 is aligned parallel with the primary section 44.

Referring to FIG. 4, a top view of the swing gate 30 shows the beast 24 ramming the gate 30 before the gate 30 has been locked. When the beast 24 rams the un-locked gate 30, the primary section 44 swings open. The safety section 46 hits the operator 22; however, because the safety section 46 is hingedly connected to the primary section 44, the safety section 46 swings out of alignment with the primary section 44. The safety section 46 thus folds away from the operator 22 as the beast 24 presses against the primary section 44. The operator 22 is thus free to . pass through a gap created between the primary section 44 and the rail 38 as the safety section 46 folds away when the beast 24 forces the primary section 44 to the open position. The only transfer of force onto the operator 22 is that necessary to have the safety section 46 swing out of alignment with the primary section 44, thus providing significant protection for the operator 22. The above description with reference to closing the gate 30 is similarly applicable to opening the gate 30.

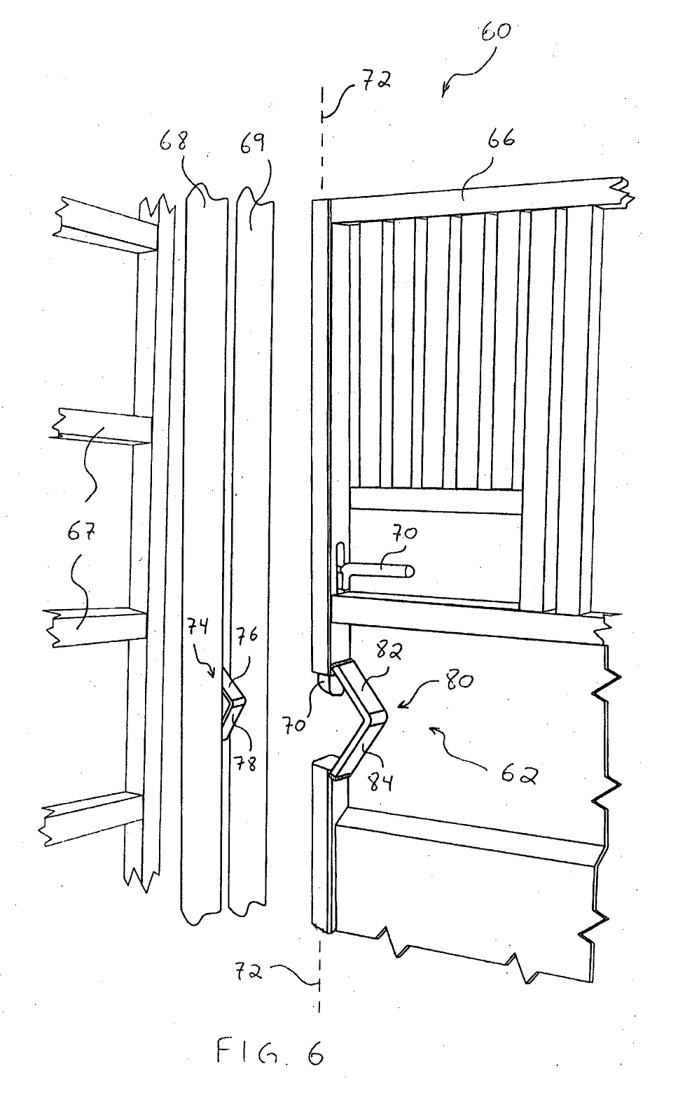

Referring to FIG. 5, a perspective view illustrates an alternative embodiment of a swing gate 60 in a closed position, including an improved gate latch 62, according to an embodiment of the present invention. The swing gate 60 includes a primary section 64 (shown only partially as a cutaway section) and a safety section 66. Operation of the primary section 64 and the safety section 66 correspond generally with operation of the primary section 44 and the safety section 46 as described above. Also, rails 67 correspond generally with the rails 38, and define a cattle pen, yard or race. However, rather than using a simple looped chain for locking the gate 60, the gate latch 62 is shown locking the gate 60 securely between two parallel bars 68, 69.

The parallel bars 68, 69 can be installed in an existing raceway and stand independently of other fencing such as the rails 67. That means that the gate latch 62 can be easily moved or retrofit in an enclosure.

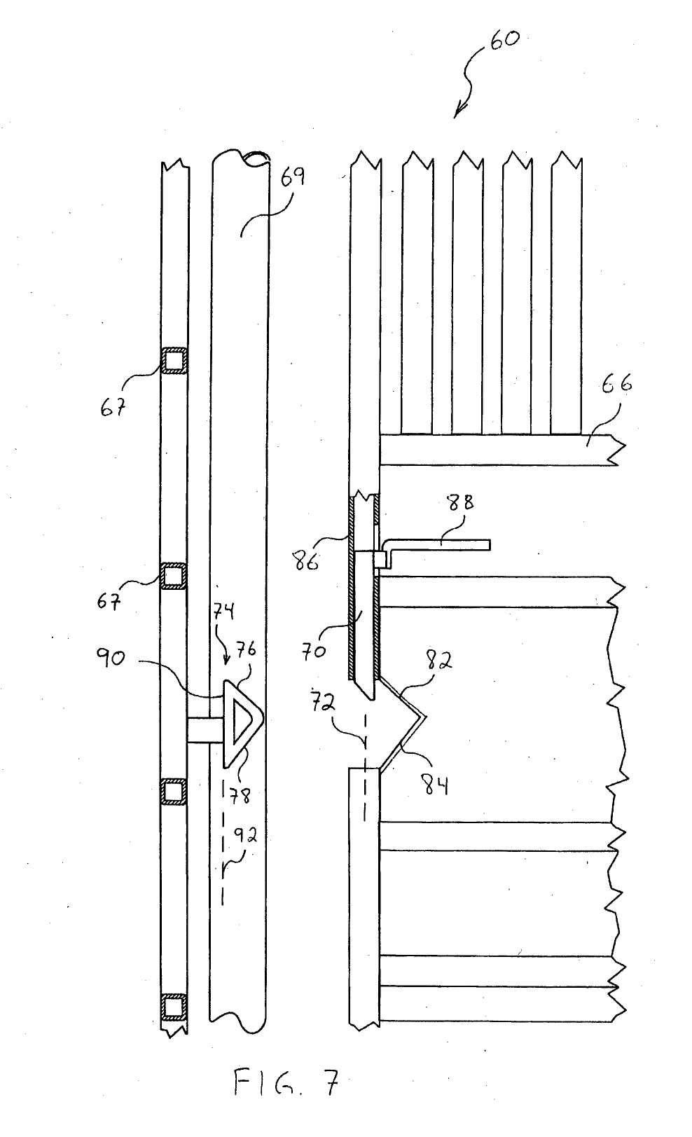

Referring to FIG. 6, a perspective view illustrates features of the gate latch 62 in an open position. The latch 62 includes a drop bolt 70 mounted to a first gate member in the form of the safety section 66. The drop bolt 70 is moveable along a locking axis 72. A striker block 74 is mounted to a second gate member in the form of the parallel bars 68, 69.

The striker block 74 comprises a first striker surface 76 extending away from the locking axis 72 at a first angle, and a second striker surface 78 extending away from the locking axis 72 at a second angle. The latch 62 also includes a housing 80 for receiving the striker block 74. As shown, the housing 80 includes a first housing surface 82 substantially parallel to the first striker surface 76; and a second housing. surface 84 substantially parallel to the second striker surface 78.

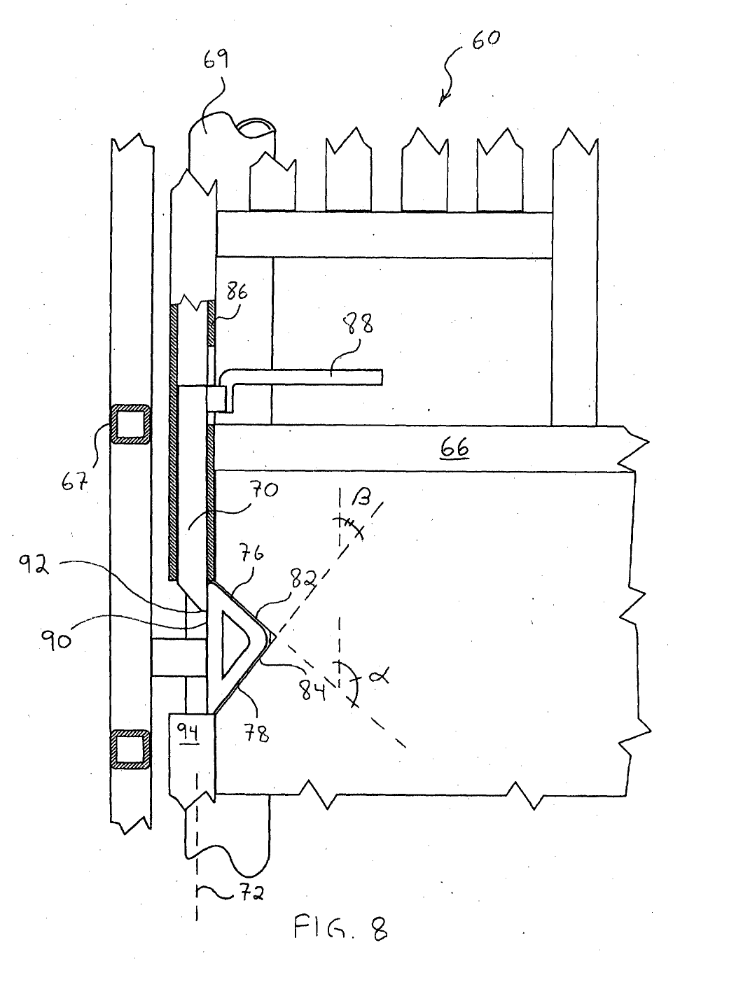

Referring to FIG. 7, a front view further illustrates the gate latch 62 with the swing gate 60 in an open position. As shown, the drop bolt 70 comprises an L-shaped bar that is received in a sleeve 86 (shown as a cutaway section) mounted to the safety section 66 (also shown as a cutaway section). A handle portion 88 enables an operator to lift the drop bolt 70 to open the latch 62.

As shown, the striker block 74 also includes a third striker surface 90 having a tangent line 92 substantially parallel to the locking axis 72. The striker block 74 can be attached either to the two parallel bars 68, 69, such as by welding, or to rails or other posts positioned behind the bars 68, 69.

Referring to FIG. 8, a front view further illustrates the gate latch 62 with the swing gate 60 in a closed position. The gate latch 62 is locked as the drop bolt 70 is shown positioned adjacent to the third striker surface 90 of the striker block 74.

During closing of the gate 60, a tip 92 of the drop bolt 70 contacts the first striker surface 76 of the striker block 74 and rides up along the first striker surface 76, lifting the drop bolt 70 in the sleeve 86. After the tip 92 rides over a point where the first striker surface 76 meets the third striker surface 90, the drop bolt 70 drops downward under the force of gravity and securely locks the gate 60 between the parallel bars 68, 69. The gate latch 62 then can be opened by lifting the handle portion 88 upwards until the tip 92 clears the point where the first striker surface 76 meets the third striker surface 90.

Those skilled in the art will appreciate that the swing gate 60 is vertically self-aligning during closing. That is because if the housing 80 is vertically misaligned with the striker block 74 during closing, they will become aligned before the gate latch 62 is fully locked. For example, if the safety section 66 is aligned too low relative to the striker block 74, the sleeve 86 will contact the first striker surface 76 during closing and will lift the safety section 66 upward into alignment. Alternatively, if the safety section 66 is aligned too high relative to the striker block 74, a frame member 94 will contact the second, striker surface 78 and will push the safety section 66 downward into alignment.

As shown, the first striker surface 76 can be substantially orthogonal to the second striker surface 78. Also, the first striker surface 76 extends away from the locking axis 72 at a first angle alpha; and the second striker surface 78 extends away from the locking axis 72 at a second angle beta.

Those skilled in the art will appreciate that various alternative embodiments of the present invention are also enabled by the present disclosure. For example, the striker surfaces 76, 78, 90 and the housing surfaces 82, 84 do not need to be flat, but could be curved, such as in a “C”, “D” or “O” shape. Also, various other horizontal/vertical orientations of the gate latch 62 are enabled herein, such as where the drop bolt 70 is spring loaded to allow the gate latch 62 to lock not by gravity but by a spring force moving the drop bolt 70 into a locked position. Thus gate latches according to the present invention can be used to lock closed various types of enclosures, including various pens, races, rooms, boxes, etc.

Advantages of the present invention include a simple self locking feature where the gate latch 62 locks automatically when the safety section 66 is closed, without manual looping of a chain or other tying mechanism. Also, precise vertical alignment of gates and rails is not necessary, as the gate latch 62 is self-aligning as described above. Further, the gate latch 62 includes no sharp objects of projections that could bruise or injure cattle or operators. For example, as shown, the striker block 74 can be recessed between the two parallel bars 68, 69, such that any cattle passing through the gate 60 might rub up against the two parallel bars 68, 69, but would not contact the striker block 74.

In another aspect, the present invention provides a gate latch as described herein, in combination with a swing gate, the swing gate comprising:
a primary section having a pivot end about which the swing gate is pivotable;
a safety section having a distal end remote from the pivot end; and a centre hinge between the primary section and the safety section,
   wherein the safety section is hingedly displaceable relative to the primary section.

Preferably, a screen is fixed to a side of the safety section of the swing gate. Preferably, the screen includes a number of holes formed therein.

Preferably, the primary section comprises two end posts and a plurality of cross bars. Preferably, the safety section comprises two end posts and a plurality of cross bars.

Preferably, the primary section is wider than the safety section.
Preferably, the distal end of the safety section is lockable to a fixed rail.
Preferably, the screen comprises corrugated steel.

Preferably, the centre hinge comprises sleeves that capture parts of an end post of the primary section.

Preferably, the swing gate is substantially as described in published international patent application WO2011/047411; the content of which is incorporated herein by reference.

The above description of various embodiments of the present invention is provided for purposes of description to one of ordinary skill in the related art. It is not intended to be exhaustive or to limit the invention to a single disclosed embodiment. Numerous alternatives and variations to the present invention with the apparent to those skilled in the art of the above teaching. Accordingly, while some alternative embodiments have been discussed specifically, other embodiments will be apparent or readily easily developed by those of ordinary skill in the art. Accordingly, this invention is intended to embrace all alternatives, modifications and variations of the present invention that have been discussed herein, and other embodiments that fall . within the spirit and scope of the above described invention.

1-20. (canceled)

21. A gate latch, comprising:
a drop bolt mounted to a first gate member, the drop bolt moveable along a locking axis; a striker block mounted to a second gate member, the striker block comprising:
a first striker surface extending away from the locking axis at a first angle; and
a second striker surface extending away from the locking axis at a second angle; and
a third striker surface having a tangent line substantially parallel to the locking axis; and
a housing for receiving the striker block;
wherein the gate latch is locked when the striker block is received in the housing and the drop bolt is positioned adjacent to the third striker surface of the striker block.

22. A gate latch according to claim 21, wherein the first gate member is a swing gate and the second gate member is a member against which the swing gate closes.

23. A gate latch according to claim 21, wherein the second gate member is a swing gate and the first gate member is a member against which the swing gate closes.

24. A gate latch according to claim 21, wherein the first and second striker surfaces are approximately orthogonal.

25. A gate latch according to claim 21, wherein the drop bolt comprises an L-shaped bar.

26. A gate latch according to claim 21, wherein the drop bolt is received in a sleeve mounted on the first gate member.

27. A gate latch according to claim 21, wherein the housing comprises a first housing surface substantially parallel to the first striker surface.

28. A gate latch according to claim 21, wherein the housing comprises a second housing surface substantially parallel to the second striker surface.

29. A gate latch according to claim 21, wherein the first striker surface, the second striker surface and the third striker surface define a triangle.

30. A gate latch according to claim 21, wherein the striker block is positioned between two parallel bars substantially parallel to the locking axis.

31. A gate latch according to claim 21, wherein the striker block is recessed between the two parallel bars.

32. A gate latch according to claim 21 in combination with a swing gate, the swing gate comprising:
a primary section having a pivot end about which the swing gate is pivotable;
a safety section having a distal end remote from the pivot end; and a centre hinge between the primary section and the safety section,
wherein the safety section is hingedly displaceable relative to the primary section.

33. A gate latch in combination with a swing gate according to claim 32, wherein a screen is fixed to a side of the safety section of the swing gate.

34. A gate latch in combination with a swing gate according to claim 33, wherein the screen includes a number of holes formed therein.

35. A gate latch in combination with a swing gate according to claim 32, wherein the primary section comprises two end posts and a plurality of cross bars.

36. A gate latch in combination with a swing gate according to claim 32, wherein the safety section comprises two end posts and a plurality of cross bars.

37. A gate latch in combination with a swing gate according to claim 32, wherein the primary section is wider than the safety section.

38. A gate latch in combination with a swing gate according to claim 32, wherein the distal end of the safety section is lockable to a fixed rail.

39. A gate latch in combination with a swing gate according to claim 32, wherein the screen comprises corrugated steel.

40. A gate latch in combination with a swing gate according to claim 32, wherein the centre hinge comprises sleeves that capture parts of an end post of the primary section.
